(19) United States
(12) Patent Application Publication
(10) Pub. No.: US 2007/0029350 A1
(43) Pub. Date: Feb. 8, 2007

(54) Granular material dispenser

(76) Inventor: Chad E. Lagace, Cohoes, NY (US)

Correspondence Address: IP GROUP OF DLA PIPER US LLP, ONE LIBERTY PLACE, 1650 MARKET ST, SUITE 4900, PHILADELPHIA, PA, 19103, US

(21) Appl. No.: 11/498,297

(22) Filed: Aug. 2, 2006

Related U.S. Application Data
(60) Provisional application No. 60/705,005, filed on Aug. 3, 2005.

(51) Int. Cl. G01F 11/28

(52) U.S. Cl. 222/425

(57) ABSTRACT

A dispenser for granular material includes a measuring chamber disposed below a storage chamber. Granular material may be selectively permitted or resisted from entering the measuring chamber from the storage chamber. Once the measuring chamber has been filled, the material within the measuring chamber may be dispensed through an opening defined within the side of the dispenser by tilting the dispenser into a substantially horizontal position.

### CROSS REFERENCE TO RELATED APPLICATION

The present Application claims the benefit of U.S. Provisional Application 60/705,005, filed Aug. 3, 2005.

### FIELD OF THE INVENTION

The invention relates to the field of dispensers for granular material.

### BACKGROUND

The problem of dispensing accurately-measured, consistent amounts of granular material has been the subject of numerous efforts. As used herein, granular material encompasses a wide variety of different materials. Possible granular materials include food seasonings, such as salt, pepper, sugar, cinnamon, or other spices, household cleaners such as carpet cleaners, lawn care chemicals such as fertilizer, ice-melting substances such as road salt, particulate materials used in a building industry such as cement, stone dust or sand, or in the manufacturing industry, such as concentrates in plastic or colorants in wax, and other similar materials.

Many presently available dispensers rely on the user ‘eyeballing’ the amount of material dispensed, often resulting in too much or too little granular material being dispensed.

Other dispensers utilize some type of measuring chamber or other intermediate passageway between the storage chamber and the dispenser exit. The dispenser is first tilted to fill the measuring chamber or other intermediate passageway, and then tilted again to dispense the granular material from the measuring chamber. Many of these dispensers require two or more rotations of the dispensers in order to dispense a single quantity of granular material, thereby decreasing the efficiency of the dispensing process. Additionally, many of these dispensers must be rotated a full 180° to dispense the material, resulting in potentially uncomfortable hand and wrist contortions, and in dispensing less than all of the material within the measuring chamber if the movement is not properly performed.

### SUMMARY OF THE INVENTION

The present invention provides a dispenser for granular material. The dispenser includes a storage chamber and a measuring chamber disposed below the storage chamber. Granular material is selectively permitted to pass from the storage chamber to the measuring chamber. A passageway leads from the measuring chamber to a dispensing opening defined within the side of the dispenser.

In one form of the dispenser of the present invention, a ramp is provided to funnel granular material at the bottom of the storage chamber into the measuring chamber. A reciprocating plate is disposed at the entrance to the measuring chamber, moving between an open position wherein it permits granular material to flow into the measuring chamber, and a closed or storage position wherein the plate resists the flow of material into the measuring chamber. The plate may be moved from one position to the other by an external control, for example, by forming the plate as part of a plunger that is accessible from the bottom of the dispenser.

Other forms of the dispenser include a dispensing passageway leading from the measuring chamber to an opening defined within a side wall of the dispenser. The dispensing passageway may be angled so that rotation of the dispenser approximately 90° to a substantially horizontal position is sufficient to cause the contents of the measuring chamber to flow into the dispensing passageway, thereby avoiding any need to rotate the dispenser a full 180°. Some examples of the bottom wall of the dispensing passageway have an angle from horizontal that is greater than the angle of the ramp at the bottom of the storage chamber.

In use, the plunger or other actuation device will typically be in its downward, storage position, resisting any flow of granular material into the measuring chamber. When a user wishes to dispense granular material, pushing up on the plunger permits granular material to flow into the measuring chamber until the measuring chamber is full. The user then releases the plunger, causing the plunger to return to the storage position, resisting the entrance of additional granular material into the measuring chamber. The user may then tilt the dispenser approximately 90° to a substantially horizontal position, causing the material within the measuring chamber to fall through the dispensing passageway, wherein it is then dispensed in a desired location.

These and other aspects of the invention will become more apparent through the following description and drawings.

### BRIEF DESCRIPTION OF THE DRAWINGS

For the purpose of illustrating the invention, there is shown in the drawings a form that is presently preferred; it being understood, that this invention is not limited to the precise arrangements and instrumentalities shown.

FIG. 1 is a perspective view of a granular material dispenser according to a preferred embodiment of the present invention.

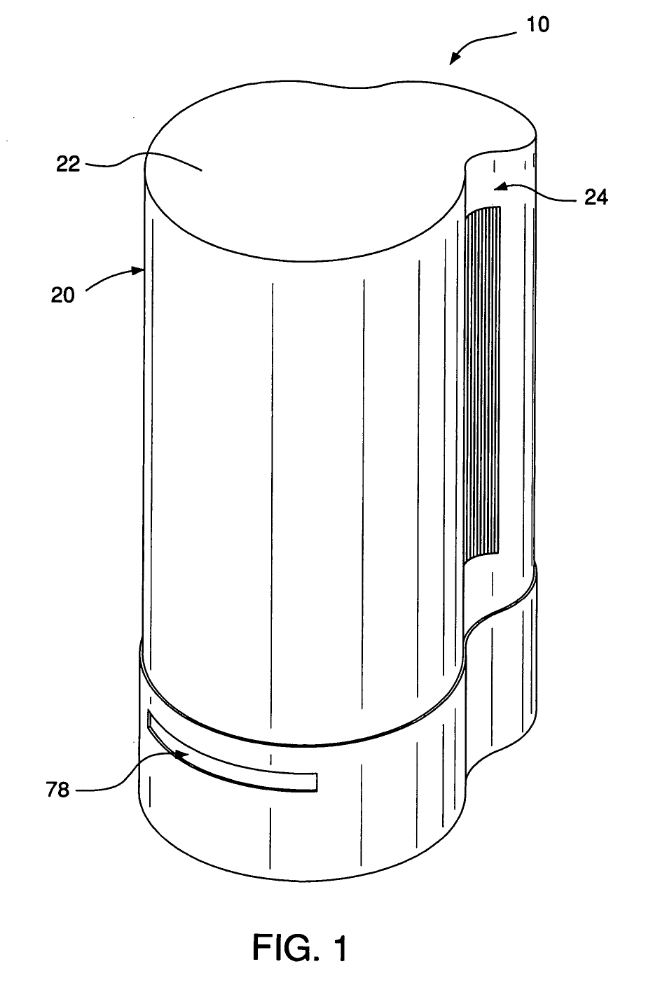

FIG. 2 is a top plan view of the granular material dispenser of FIG. 1.

FIG. 3 is a cross sectional perspective view of the granular material dispenser of FIG. 2, taken along line A-A in FIG. 2.

FIG. 4 is a cross-sectional perspective view of the granular material dispenser of FIG. 2, taken along line A-A in FIG. 2.

FIG. 5 is a perspective view of a plunger section according to a preferred embodiment of the present invention.

### DETAILED DESCRIPTION

It will be appreciated that the following description is intended to refer to specific embodiments of the invention selected merely for illustration, and not to define the scope of the invention.

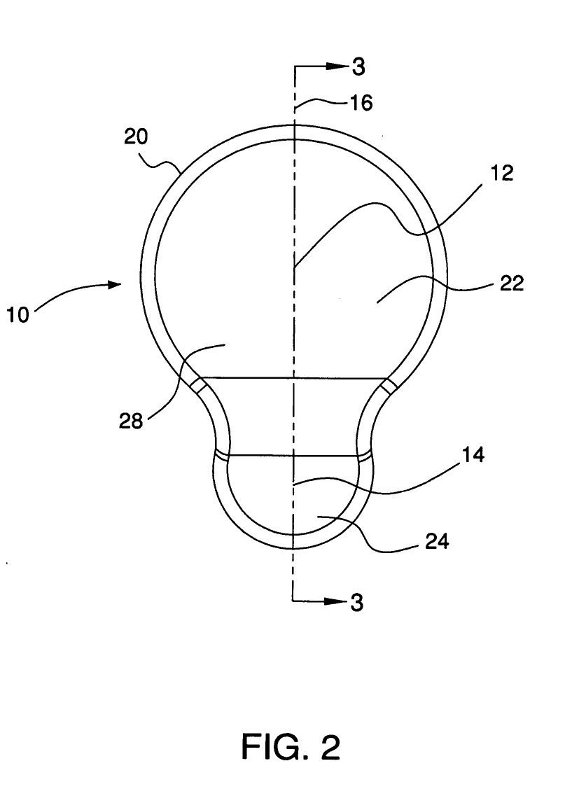

In the figures, like reference numerals indicate like elements or features of the preferred embodiments shown here. In the figures, a preferred embodiment of a granular material dispenser is shown and generally designated by the numeral 10. The dispenser 10 comprises an outer surface 20, defining a generally cylindrical portion 22, and a generally narrowed handle portion 24. Preferably, the narrowed handle portion is adapted to be grasped by a person's hand to allow for easy maneuverability of the dispenser 10. A major longitudinal axis 12 extends through the cylindrical portion 22. A minor longitudinal axis 14 extends through the handle portion 24. The major and minor longitudinal axes 12, 14 are preferably parallel. A bisecting plane 16 extends through the dispenser 10. The bisecting plane 16 includes the two axes 14. Preferably, half of each of the cylindrical portion 22 and the handle portion 24 are disposed on each side of the bisection plane. Generally, the cylindrical portion 22 has a larger diameter than the handle portion 24, as best seen in FIG. 2.

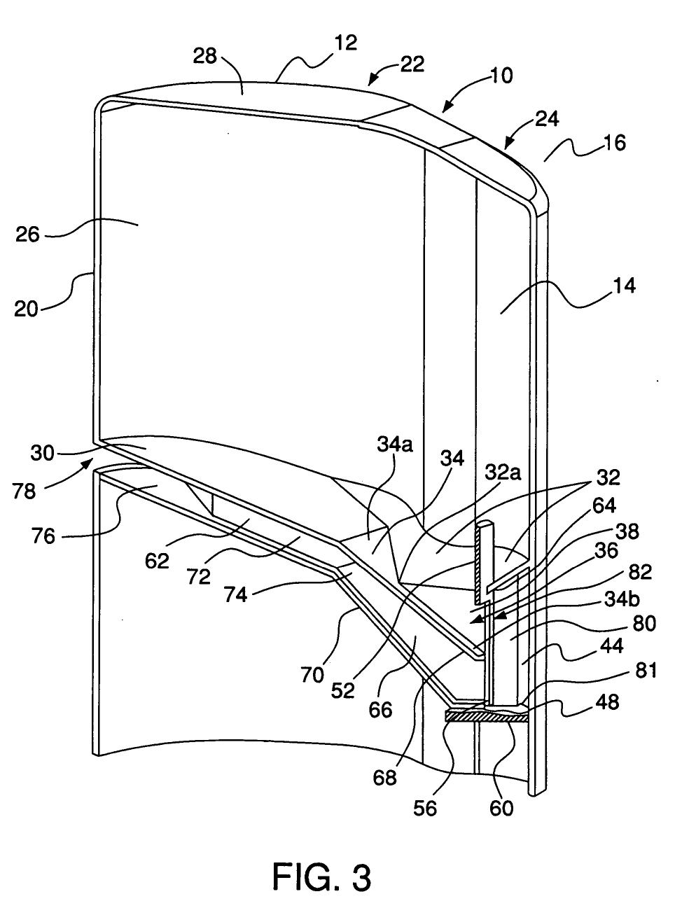

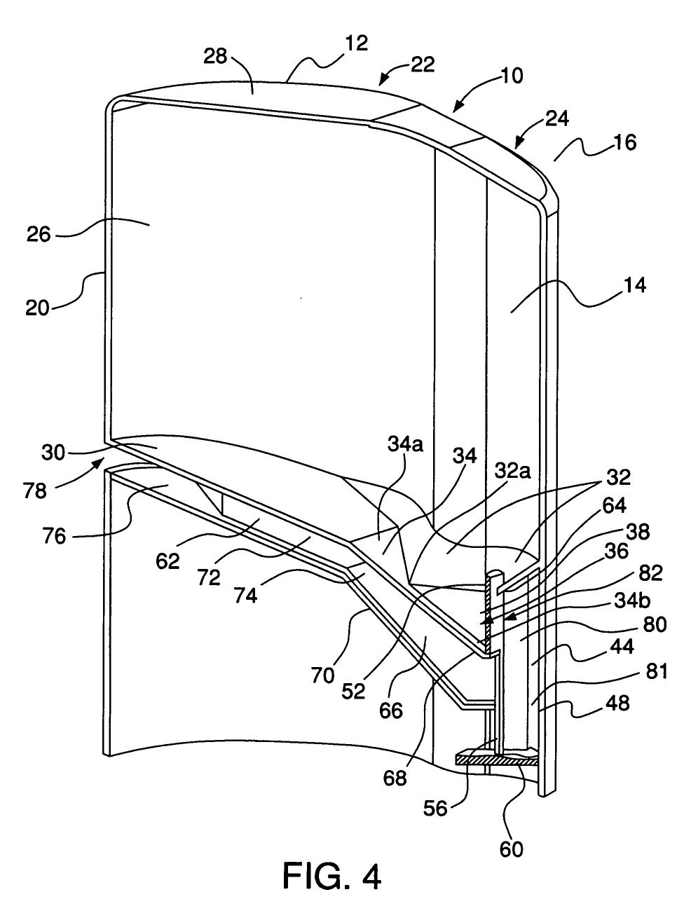

Turning now to the interior of the dispenser 10, the terms upper and lower shall refer respectively to the directions up or down when viewing dispenser 10 as viewed in FIGS. 3 and 4. Those skilled in the art will recognize that FIGS. 3 and 4 show one-half of a dispenser 10, according to a preferred embodiment of the present invention. It is preferable that the other half of the dispenser 10 be a mirror image of the dispenser shown in FIGS. 3 and 4. Certain parts of the dispenser are shown and mentioned once for ease of description; however, those skilled in the art will recognize that they may have an opposing counterpart.

A storage chamber 26 is disposed in an upper portion of the dispenser 10. The storage chamber 26 is laterally defined by the outside wall 20. The outside wall 20 generally defines all of the lateral edges of the storage chamber 26. The storage chamber 26 preferably has a profile, when viewed from the top of the chamber 26, that is similar to the profile of the dispenser, as best seen in FIG. 2.

Referring now to FIGS. 3-4, a measuring chamber 44 is disposed within the handle portion 24, below the storage chamber 26. The measuring chamber 44 is sized to accommodate a predetermined amount of material therein. The predetermined amount of material accommodated by the measuring chamber 44 is generally related to a predetermined amount of material to be dispensed from the dispenser 10.

A top portion 28 of the outside wall 20 defines the top of the storage chamber 26. A bottom panel 30 defines at least a portion of the bottom of the storage chamber 26. The bottom of the storage chamber 26 is further defined by a series of ramps. A first ramp 32 is adapted to slope from the outside wall 20 of both the cylindrical portion 22 and the handle portion 24 towards the bisecting plane 16. Those skilled in the art will recognize that although not shown in FIGS. 3-4, an opposing first ramp preferably slopes towards the first ramp 32 from an opposing side of the dispenser 10.

A second ramp 34 is adapted to slope from the center of the dispenser towards the handle portion 24. A top portion 34a of the second ramp 34 intersects the bottom panel 30. The second ramp 34 also intersects a bottom edge 32a of the first ramp 32. A bottom portion 34b of the second ramp 34 is disposed proximate to the measuring chamber 44.

At a bottom section of the ramps 32, 34, a loading chute 36 is adapted to receive material that has slid down the ramps 32, 34. The loading chute 36 comprises two steeply sloped opposing walls 38 (only one wall 38 of the loading chute 36 is shown in FIG. 3, an opposing wall (not shown) preferably is a mirror image of the wall 38, across the bisecting plane 16). The wall 38 of the loading chute 36 preferably intersects both the first and second ramps proximate to the measuring chamber 44.

Preferably, the slopes of the ramps 32, 34 and the wall 38 of the loading chute 36 are such that dry material placed in the storage chamber will slide through a bottom portion of loading chute 36 with only the force of gravity, without requiring the user to tilt the dispenser. Preferably, this is generally done by inclining the ramps 32, 34 and the wall 38 at an angle to the horizontal axis that is greater than the inclination angle of the dry material to be stored in the storage chamber 26 when the dispenser is in the upright storage position. The inclination angle refers to the angle at which the dry material will flow downwards through only the force of gravity, without the use of additional forces or tilting of the dispenser 10. When the ramps 32, 34 and the wall 38 are inclined as described above, the dry material in the storage chamber 26 will always be disposed at the bottom of the storage chamber 26, proximate to the measuring chamber 44.

The measuring chamber 44 is disposed in a lower portion of the dispenser, within the handle portion 24. Preferably, the measuring chamber 44 is partially laterally defined by the outside wall 20 of the handle portion 24. Preferably, an interior measuring wall 80 serves to further laterally define the measuring chamber 44. A measuring passageway 82 passes through the interior measuring wall 80. The measuring passageway 82 links the measuring chamber 44 with the storage chamber 26. Preferably, the measuring chamber 44 is sized to allow a predetermined amount of dry material therein before becoming completely full. The measuring passageway 82 is defined on a top edge 64 by the ramp 32. The bottom of the measuring passageway 82 is defined by the bottom measuring wall 81.

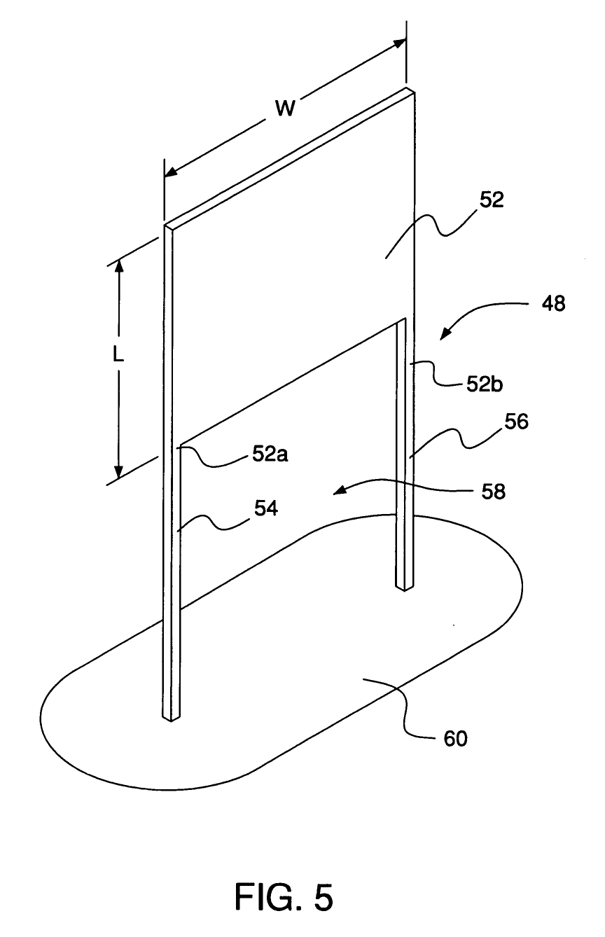

Referring now to FIGS. 3-5, a plunger portion 48 is disposed between the storage chamber 26 and the measuring chamber 44. The plunger 48 is generally disposed within the handle portion 24 of the dispenser 10. The plunger portion 48 preferably comprises an upper plate portion 52, and a plurality of leg portions 54, 56. The leg portions 54, 56 and the upper plate portion 52 are generally co-planar. The plate 52 is generally rectangular, having a width “W” and a length “L.” Preferably, each of the leg portions 54 and 56 connect to the upper plate portion 52 at lower outside corners 52a, 52b of the plate portion 52. The leg portions 54, 56 extend generally downward from the plate portion 52 and generally parallel to each other. A passageway 58 is disposed between the leg portions 54 and 56. An operator portion 60 is disposed at an opposite end of the leg portions from the plate 52. Preferably, the operator portion 60 is in a plane that is substantially perpendicular to that of the leg portions and the plate portion. The operator portion 60 is generally circular, having a cross sectional area that is slightly smaller than that of the handle portion 24. The bottom of the dispenser is generally open, thereby allowing the user to reach the operator portion 60 to operate the plunger 48. Although not shown, an operator tab may extend through the outside wall 20 of the handle in a direction away from the minor longitudinal axis 14. The operator tab may be generally co-planar with the operator portion. Preferably, the operator tab will facilitate the operation of the plunger 48 without the user having to lift the dispenser 10 to reach under the bottom of the dispenser 10.

The plunger portion 48 is vertically translatable along a path that is generally parallel to the longitudinal axes 12, 14 of the dispenser 10. The range of motion of the plunger portion 48 is such that when the plunger 48 is disposed in a measuring position, shown in FIG. 3, which is generally the uppermost position of the plunger 48, the plate portion 52 extends above the ramp 32, into the storage chamber 26. In such a disposition, the passageway 58 of the plunger 48 is aligned with the measuring passageway 82, thereby allowing the gravity driven flow of material from the storage chamber 26 into the measuring chamber 44, when the dispenser is in the upright position.

At the opposite end of the plunger 48 range of motion is the storage position, as shown in FIG. 4. In the storage position, the lowermost position of the plunger 48, the plate 52 of the plunger 48 is disposed within the measuring passageway 82. In the storage position, the plate 52 of the plunger 48 restricts the flow of dry material from the storage chamber 26 to the measuring chamber 44. The plunger 48 may be biased in the storage position, thereby restricting the flow of dry material from the storage chamber 26 at all times except when the plunger 48 is operated to the measuring position. In an embodiment where the plunger 48 is biased in the storage position, force must be applied to the plunger 48 to force it to the measuring position. After the force is removed from the plunger 48, it is preferable that plunger 48 returns to the storage position.

A bottom portion of the loading chute 36 is adapted to meet the measuring chamber 44 at a position that is at a predetermined distance below the top 64 of the measuring chamber 44. Preferably, the predetermined distance is slightly smaller than the length L of the plate portion 52 of the plunger portion 48. The measuring passageway is defined on both sides by the measuring wall 80. Preferably the width of the measuring passageway 82 is slightly less than the width W of the plate 52. Thus, as mentioned above, when the plunger 48 is disposed in a storage position, the plate portion 52 restricts the flow of material from the storage section 26, through the measuring passageway 82, to the measuring section 44.

A dispensing passageway 62 is disposed generally below the bottom part of the storage chamber 26. The upper portion of the dispensing passageway 62 may be defined by the bottom portion of the dispensing chamber 30. Preferably, a receiving portion 66 of the dispensing passageway 62 is disposed at a part of the dispensing passageway 62 that is closest to the measuring chamber 44. Preferably, an upper wall 68 of the receiving portion 66 extends along bottom surface of the ramp 34. Therefore, the upper wall 68 of the receiving portion 66 and the ramp 34 generally share the same angle from horizontal. Those skilled in the art will recognize that the ramp 34 and upper wall 68 may simply be two sides of the same structure.

A bottom wall 70 of the receiving portion 66 is preferably sloped at a greater angle from the horizontal than the upper wall 68. The respective slopes of the upper and lower wall 68 and 70 allow the collection chute 66 to have a greater cross-sectional area at a portion of the collection chute 66 that are closer to the measuring section 44. This larger area, in conjunction with the steeper slope of the lower wall facilitates the flow of material through the dispensing passageway 62, rather than back into the storage chamber 26, from the measuring chamber 44, when the dispenser 10 is tilted about a horizontal axis that is generally perpendicular to the bisecting plane 16. Additionally, the receiving portion 66 is adapted to receive material that is allowed to flow into the measuring chamber 44 before the dispenser 10 is tilted at all. The volume of material that is permitted to flow into the receiving portion 66 is preferably part of the predetermined amount of material to be dispensed.

A central passageway 72 extends from an upper portion 74 of the collection chute 66 in a direction away from the measuring chamber 34. Preferably, the central passageway extends towards a dispersion section 76. The central passageway 72 is less steeply sloped than the ramp 34 or the bottom wall 70 of the collection chamber 66. The central passageway 72 is inclined so that a lower portion of the central passageway 72 is closer to the measuring section 44 and an upper portion of the central passageway 72 is farther away from the measuring section 44.

Preferably, the dispersion section 76 links the central passageway 72 with a dispensing port 78. The dispensing port 78 is a generally rectangular aperture in the outer surface 20 of the dispenser 10. The dispensing port 78 facilitates the exit of dry material from the dispenser 10. Preferably, the central passageway 72 has a much smaller cross sectional area than the dispensing port 78. Accordingly, the dispersing section 76 is generally fan shaped (or pie shaped) having a smaller end closest to the central passageway and a larger end closest to the dispensing port 78. Although not shown, there may be at least one internal baffle disposed within the dispersion section 76. The at least one internal baffle may serve to facilitate the equal distribution of material across the entire cross-sectional area of the dispensing port 78.

During operation, the storage chamber 26 of the dispenser 10 is generally full of dry particulate material. Initially, the plunger section 48 is disposed in a storage position of FIG. 4, wherein the plate section 52 generally restricts any flow of material from the storage section 26, through the measuring passageway 82, to the measuring section 44. Preferably, the plunger 48 is operable from the storage position of FIG. 4 to the measuring position of FIG. 3, thereby pushing the plate section 52 above the top of the measuring chamber 44 and allowing material to pass through the measuring passageway 82 and the passageway 58 of the plunger from the storage section 26 to the measuring section 44. The passageway 58 extends downward to the bottom of the measuring chamber 44, thereby allowing material to flow into the receiving channel 66, when the material is allowed to flow into the measuring chamber.

Upon filling of the measuring chamber 44 with the material, the plunger 48 is allowed to return to a storage position of FIG. 4. When the plunger 48 returns to the storage position, the passageway 58 is then disposed between the measuring section 44 and the receiving channel 66 and the plate 52 is disposed between the storage chamber 26 and the measuring chamber 44. At this point, the material is permitted to flow only from the measuring chamber 44 into the receiving chamber 66 and ultimately through the dispensing channel 62, when the dispenser 10 is tilted.

To dispense material from the dispenser 10, it the user grasps the dispenser 10 by the handle 24. The user then tilts the dispenser so that the handle 24 is generally disposed above the circular portion 22. In such a tilted position, the dispensing port 78 is disposed on a bottom side of the dispenser 10. When the dispenser 10 is tilted in such a way, the material will flow, through the force of gravity, from the measuring chamber 44 through the collection chute 66 through the central passageway 72 into the dispersion chamber 76 and eventually the material will be dispensed though the dispensing port 78.

Benefits of the present invention include allowing the user to operate the plunger 48 and measure a predetermined quantity of dry material without having to tilt the dispenser 10 from the vertical position. The present invention provides a simple, easy to operate device for measuring a predetermined amount of dry material and dispersing said dry material with a minimum number of steps.

A variety of modifications to the embodiments described will be apparent to those skilled in the art from the disclosure provided herein. Thus, the invention may be embodied in other specific forms without departing from the spirit or essential attributes thereof and, accordingly, reference should be made to the appended claims, rather than to the foregoing specification, as indicating the scope of the invention.

What is claimed is:

1. A dispenser for granular material, comprising:
at least one side wall;
a storage chamber defined within the at least one side wall;
a measuring chamber disposed adjacent to a lower portion of the storage chamber and in communication with the storage chamber;
means for selectively permitting a flow of granular material from the storage chamber into the metering chamber; and
an opening defined within the at least one side wall, the opening being in communication with the metering chamber.

2. The dispenser according to claim 1, wherein the means for selectively permitting and resisting a flow of granular material from the storage chamber into the metering chamber include a plate structured to reciprocate between an open position wherein the plate permits granular material to flow from the storage chamber into the measuring chamber, and a closed position wherein the plate resists the passage of granular material from the storage chamber into the measuring chamber.

3. The dispenser according to claim 2, wherein the plate is biased towards its closed position.

4. The dispenser according to claim 3, wherein:
the open position of the plate is above the closed position; and
the plate is biased towards its closed position by gravity.

5. The dispenser according to claim 2, further comprising means for permitting a user to move the plate between its open and closed positions, the means for permitting a user to move the plate between its open and closed positions being accessible from an exterior location of the dispenser.

6. The dispenser according to claim 5, wherein the plate is formed as a part of a plunger.

7. The dispenser according to claim 5, wherein the plate's direction of reciprocation is substantially vertical.

8. The dispenser according to claim 1, further comprising a passage defined between the measuring chamber and the opening in the side wall.

9. The dispenser according to claim 8, wherein a bottom wall of the passage is angled from horizontal, with a lower end adjacent the metering chamber, and an upper end adjacent the side wall.

10. The dispenser according to claim 1, wherein the storage chamber includes a ramped bottom wall, with a lowermost portion of the ramped bottom wall being disposed adjacent to the measuring chamber.

11. The dispenser according to claim 10, wherein:
a bottom wall of the passage is angled from horizontal, with a lower end adjacent the metering chamber, and an upper end adjacent the side wall; and
the bottom wall of the passage has a greater angle from horizontal than the ramped bottom wall of the storage chamber.

12. A dispenser for granular material, comprising:
at least one side wall;
a storage chamber defined within the at least one side wall;
a measuring chamber disposed below the storage chamber and in communication with the storage chamber;
a chute structured to direct granular material from the storage chamber to the measuring chamber;
a plate reciprocating between a storage position wherein it blocks the chute, and an open position wherein the plate is spaced from the chute; and
an opening defined within the at least one side wall, the opening being in communication with the metering chamber.

13. The dispenser according to claim 12, wherein the plate is biased towards its closed position.

14. The dispenser according to claim 13, wherein:
the open position of the plate is above the closed position; and
the plate is biased towards its closed position by gravity.

15. The dispenser according to claim 12, further comprising means for permitting a user to move the plate between its open and closed positions, the means for permitting a user to move the plate between its open and closed positions being accessible from an exterior location of the dispenser.

16. The dispenser according to claim 15, wherein the plate is formed as a part of a plunger.

17. The dispenser according to claim 15, wherein the plate's direction of reciprocation is substantially vertical.

18. The dispenser according to claim 12, further comprising a passage defined between the measuring chamber and the opening in the side wall.

19. The dispenser according to claim 18, wherein a bottom wall of the passage is angled from horizontal, with a lower end adjacent the metering chamber, and an upper end adjacent the side wall.

20. The dispenser according to claim 19, wherein:
a bottom wall of the passage is angled from horizontal, with a lower end adjacent the metering chamber, and an upper end adjacent the side wall; and
the bottom wall of the passage has a greater angle from horizontal than the chute.
